(19) United States
(12) Patent Application Publication
(10) Pub. No.: US 2024/0119578 A1
(43) Pub. Date: Apr. 11, 2024

(54) DYNAMIC IMAGE-QUALITY VIDEO PLAYING METHOD, APPARATUS, ELECTRONIC DEVICE, AND STORAGE MEDIUM

(71) Applicant: Beijing Zitiao Network Technology Co., Ltd., Beijing (CN)

(72) Inventors: Dian YANG, Beijing (CN); Shenglan HUANG, Culver City, CA (US)

(21) Appl. No.: 18/572,164

(22) PCT Filed: Aug. 16, 2022
(86) PCT No.: PCT/CN2022/112892

§ 371 Date: Dec. 19, 2023

(30) Foreign Application Priority Data
Sep. 7, 2021 (CN) 202111045132.2

(51) Int. Cl. G06T 7/00

(52) U.S. Cl. CPC G06T 7/0002; G06T 2207/30168

(57) ABSTRACT

The embodiments of the present disclosure provide a dynamic image quality video playing method, apparatus, electronic device and storage medium. The method includes: receiving a switch command for a video information stream, the switch command being for switching a target video played in the video information stream; determining an image quality selection strategy based on the switch command, and video information of the target video corresponding to the switch command, the image quality selection strategy being for characterizing image quality levels when playing a video to be played in the video information stream in different network conditions; and determining a target image quality level based on the image quality selection strategy and a current network condition, and playing, based on the target image quality level, the video to be played in the video information stream.

The present disclosure claims the priority to the CN patent application No. 202111045132.2 entitled “DYNAMIC IMAGE-QUALITY VIDEO PLAYING METHOD, APPARATUS, ELECTRONIC DEVICE, AND STORAGE MEDIUM” filed on Sep. 7, 2021, the disclosure of which is hereby incorporated by reference in its entity.

### FIELD

The present disclosure generally relates to the field of computer technologies, and more specifically, to a dynamic image-quality video playing method, apparatus, electronic device, and storage medium.

### BACKGROUND

Feed stream, also known as information stream, is a technology that pushes information to users based on recommended information and personalized data. Video playback based on feed streams is widely applied in video applications such as short videos and the like. In the background, due to different network conditions, device types, user habits and other factors, different users have different requirements for image quality during video playback.

In the relevant technologies, the image quality setting of the video played in a feed stream is typically dependent on network conditions. For example, image quality of a video at different network speeds is determined by a “network speed-code rate mapping model” characterizing a mapping relationship between a network speed and a video bit rate.

### SUMMARY

Embodiments of the present disclosure provide a dynamic image quality video playing method, apparatus, electronic device and storage medium, to solve the problem that users' personalized needs for image quality in different network conditions cannot be met according to the prior technologies.
In a first aspect, embodiments of the present disclosure provide a dynamic image quality video playing method, comprising:
receiving a switch command for a video information stream, the switch command for switching a target video played in the video information stream; determining an image quality selection strategy based on the switch command, and video information of the target video corresponding to the switch command, the image quality selection strategy for characterizing image quality levels when playing a video to be played in the video information stream in different network conditions; and determining a target image quality level based on the image quality selection strategy and a current network condition, and playing, based on the target image quality level, the video to be played in the video information stream.
In a second aspect, embodiments of the present disclosure provide a dynamic image quality video playing apparatus, comprising:
a receiving module for receiving a switch command for a video information stream, the switch command for switching a target video played in the video information stream;
a determining module for determining an image quality selection strategy based on the switch command, and video information of the target video corresponding to the switch command, the image quality selection strategy for characterizing image quality levels when playing a video to be played in the video information stream in different network conditions; and
a playing module for determining a target image quality level based on the image quality selection strategy and a current network condition, and playing, based on the target image quality level, the video to be played in the video information stream.
In a third aspect, according to one or more embodiments of the present disclosure, there is provided an electronic device, comprising:
a processor, and a memory communicatively connected with the processor;
the memory storing computer execution instructions;
the processor executing the computer execution instructions stored on the memory to implement the dynamic image quality video playing method of the first aspect and various possible designs of the first aspect.
In a fourth aspect, according to one or more embodiments of the present disclosure, there is provided a computer-readable storage medium having computer execution instructions stored therein, wherein the computer execution instructions, when executed by a processor, implements the dynamic image quality video playing method of the first aspect and various possible designs of the first aspect.
In a fifth aspect, embodiments of the present disclosure provide a computer program product comprising a computer program, wherein the computer program, when executed by a processor, implements the dynamic image quality video playing method of the first aspect and various possible designs of the first aspect.
In a sixth aspect, embodiments of the present disclosure provide a computer program, where the computer program, when executed by a processor, implements the dynamic image quality video playing method of the first aspect and various possible designs of the first aspect.

### BRIEF DESCRIPTION OF THE DRAWINGS

In order to make clear the technical solution according to embodiments of the present disclosure or the prior art technology, brief introduction will be provided below on the drawings necessary for the embodiments or the prior art technology. Obviously, the drawings described below only illustrate some embodiments of the present disclosure, based on which the ordinary skilled in the art could apparently obtain others, without doing creative work.

FIG. 1 illustrates a diagram of an application scenario of a dynamic image-quality video playing method provided by embodiments of the present disclosure;

FIG. 2 illustrates a schematic diagram of automatically setting image quality for a video application provided by embodiments of the present disclosure;

FIG. 3 illustrates a flowchart I of a dynamic image-quality video playing method provided by embodiments of the present disclosure;

FIG. 4 illustrates a schematic diagram of a high image quality strategy and a high fluency strategy provided by embodiments of the present disclosure;

FIG. 5 illustrates a schematic diagram of determining, based on a buffering duration of a target video, an image quality selection strategy provided by embodiments of the present disclosure;

FIG. 6 illustrates a further schematic diagram of determining, based on a buffering duration of a target video, an image quality selection strategy provided by embodiments of the present disclosure;

FIG. 7 illustrates a flowchart II of a dynamic image-quality video playing method provided by embodiments of the present disclosure;

FIG. 8 illustrates a schematic diagram of a structure of a dynamic image-quality video playing apparatus provided by embodiments of the present disclosure;

FIG. 9 illustrates a schematic diagram of a structure of an electronic device provided by embodiments of the present disclosure; and

FIG. 10 illustrates a schematic diagram of a hardware structure of an electronic device provided by embodiments of the present disclosure.

### DETAILED DESCRIPTION OF EMBODIMENTS

In order to make the objective, technical solution, and advantages of the present disclosure more apparent, with reference to the drawings, a clear, complete description will be provided below about the technical solution provided by the embodiments of the present disclosure. Obviously, the embodiments described here are only a part of embodiments of the present disclosure, rather than all of them. Based on the embodiments described here, the ordinary skilled in the art could acquire all of the other embodiments falling into the scope of protection of the present disclosure, without doing creative work.

Hereinafter, the application scenario of embodiments of the present disclosure is described:

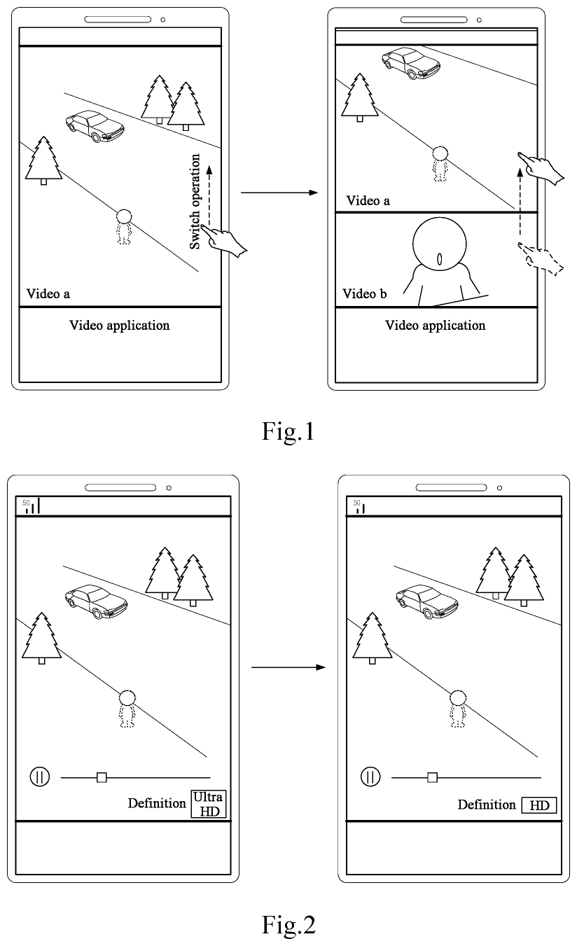

FIG. 1 illustrates a diagram of an application scenario of a dynamic image-quality video playing method provided by embodiments of the present disclosure. The dynamic image-quality video playing method provided by embodiments of the present disclosure can be applied to the information stream-based video playback scenario. More specifically, as shown in FIG. 1, the execution body of the method provided by the embodiments may be a terminal device such as a smart phone, and the terminal device has an information stream (feed stream) technology-based video application (APP) run therein, in which videos are played in the form of video information stream. When watching a target video (shown as video a) in the video information stream, a user may perform a switch operation (shown as swipe up) via a touchscreen of the terminal device, to switch the target video and play a video (shown as video b) placed after the target video in the video information stream. In addition, the terminal device is communicatively connected with a server. When the video application within the terminal device plays the target video, the terminal device loads video data of the target video for playback by accessing the server, or preloads the video to be played in the video information stream. In the process, the video loaded (or preloaded) by the terminal device corresponds to a plurality of image quality levels. Higher image quality is accompanied with a higher video resolution and a higher frame rate (i.e., a higher bit rate). Correspondingly, the terminal device requires more traffic and occupies more bandwidth when loading the video from the server.

In an implementation according to the relevant technology, setting image quality of a video to be played in the video information stream is typically determined based on network quality, i.e., video quality is determined by a “network speed-bit rate mapping model” characterizing a mapping relationship between network quality and an image quality level. FIG. 2 illustrates a schematic diagram of automatically setting image quality for a video application provided by embodiments of the present disclosure. As shown therein, when the network in a good condition, the video application plays a video at a high resolution, for example, the “ultra HD” level in FIG. 2; when the network is in a poor condition (as shown therein, the communication signal of the terminal device is switched from a 5G signal to a 3G signal), the video application plays the video at a low resolution, for example, the “normal HD” level in FIG. 2, to prioritize the fluency of playing the video and reducing image freezing, but this simultaneously deteriorates the video resolution. However, as users have different needs for video quality, setting video quality through the same “network speed-bit rate mapping model” cannot meet users' personalized needs in different network conditions and thus affects users' experience in video watching.

In a further implementation according to the relevant technology, the video application is based on a video level set fixedly by a user. For example, if a user manually sets the video resolution to an “ultra HD” level, the video is played at the resolution of the “ultra HD” level irrespective of the network condition, to prioritize the video definition and improve the image quality, but this may bring about the video freezing problem.

Therefore, the video watching experience is, in fact, determined by factors in two dimensions, i.e., video bit rate (video resolution, video frame rate) and video fluency. Different users attach different importance to the video bit rate and the video fluency. For example, some users care more about the video bit rate but is insensitive to video freezing, while some others value more the video fluency, which means being sensitive to video freezing, but care less about the video bit rate. This actually involves at least two different image-quality selection strategies for determining video image quality in different network conditions. Different users may select different image-quality selection strategies according to their personalized needs.

In view of the above, only with the technical solution of determining video quality based on the network condition, the relevant technology cannot implement different image quality selection strategies as mentioned above, but determines a fixed video image quality based on only one strategy, for example, a “network speed-bit rate mapping relationship;” therefore, it cannot fit the users' preferences for different image quality in different network speed conditions, affecting the user's experience in video watching.

Hence, there arises an urgent need for a solution that can automatically predict a user's image quality selection strategy (image quality preference), and play a video in a video information stream based on the image quality selection strategy, to meet personalized image quality needs of different users in different network conditions. Accordingly, embodiments of the present disclosure provide a dynamic image-quality video playing method to solve the above-mentioned problem.

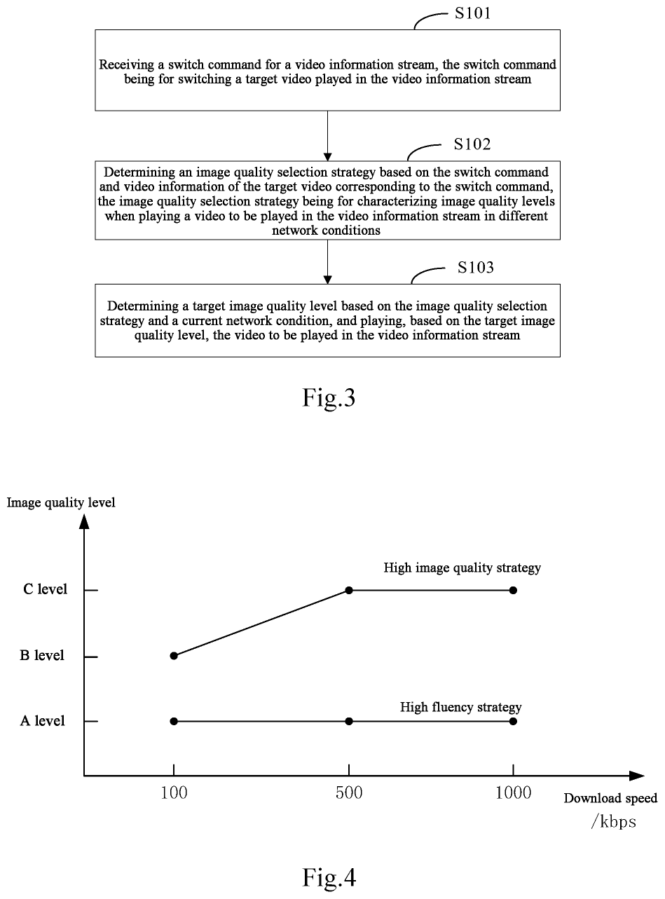

FIG. 3 illustrates a flowchart I of the dynamic image-quality video playing method provided by embodiments of the present disclosure. With reference to FIG. 3, the method according to the embodiment can be applied to a terminal device. The dynamic image-quality video playing method includes:

Step S101: receiving a switch command for a video information stream, where the switch command is used to switch a target video played in the video information stream.

As an example, the video information stream is generated based on recommended information, which characterizes information of a video being played by the terminal device and a set of videos to be played, and can be embodied on the terminal device side as a plurality of videos that can be played continuously. Wherein, the video being played by the terminal device is the target video in the video information stream, and videos played after the target video are videos to be played in the video information stream.

Further, the terminal device includes a touchscreen. In the process where the terminal device plays the video in the video information stream via the touchscreen, when a user performs the switch operation via the touchscreen, the terminal device receives a corresponding switch command and responds to it, to switch the video being currently played (i.e., the target video) and play a next (or previous) video in the video information stream. As an example, the user implements the switch operation via the touchscreen by, for example, swiping up or down on the touchscreen, clicking the virtual button “Next” on the touchscreen, or the like.

Step S102: based on the switch command and video information of the target video corresponding to the switch command, determining an image quality selection strategy for characterizing image quality levels when playing the video to be played in the video information stream in different network conditions.

By means of example, after obtaining the switch command corresponding to the switch operation, the switch command is used to indicate the terminal device to switch the target video being played by the terminal device, and based on the switch command and the video information of the target video, an image quality selection strategy characterizing the user's preference for image quality is determined. The video information of the target video is information used to characterize the playing state of the target video. More specifically, for example, the video information of the target video includes a buffer duration of the target video during play, and a play duration of the target video before triggering the switch command, and the like. When watching the video, the user may perform correspondingly the switch operation based on the play state of the target video, for example, whether video buffering (i.e., freezing) occurs. A freezing-sensitive user may rapidly switch the video when the video freezes; in turn, a freezing-insensitive user may not switch the video in a short time. Therefore, the video freezing state can be determined based on the video information of the target video, the current network condition can be further determined, and the image quality level preferred by the user (i.e., the image quality selection strategy) in the current network condition can be determined based on the user's response (i.e., the switch command). Specifically, for example, a high image quality level is selected in the case of normal network condition while a low image quality level is selected in the case of poor network condition; or, the high image quality level is selected in the case of normal network condition while the high image quality level is still selected in the case of poor network condition; or the low image quality is directly selected in the case of normal network condition, or the like.

In a possible implementation, the image quality selection strategy includes a high image quality strategy or high fluency strategy. The high image quality strategy is used to indicate the terminal device to play a video to be played in the video information stream at a first image quality level in a first network condition, and the high fluency strategy is used to indicate the terminal device to play a video to be played in the video information stream at a second image quality level in a first network condition, where a bit rate corresponding to the first image quality level is greater than a bit rate corresponding to the second image quality level. Specifically, the first network condition includes one or more download speeds, and the terminal device is in the first network condition, i.e., the terminal device has a certain download speed or certain download speeds. The high image quality strategy may be a curve characterizing a “download speed-image quality level” mapping relationship; and the high fluency strategy may be a further curve characterizing a “download speed-image quality level” mapping relationship. In different network conditions, the high quality levels corresponding to the high image quality strategy and the high fluency strategy are different. FIG. 4 illustrates a schematic diagram of a high quality strategy and a high fluency strategy provided by embodiments of the present disclosure. As shown therein, as an example, when the download speed is 100 kbps (kilobits per second), 500 kbps and 1,000 kbps, respectively, the image quality levels corresponding to the high image quality strategy are “B level,” “C level” and “C level,” respectively, and the image quality levels corresponding to the high fluency strategy are “A level,” “A level” and “A level.” By means of example, the image quality level corresponding to the “C level” may be “ultra HD,” the image quality level corresponding to the “B level” may be “HD,” and the image quality level corresponding to the “C level” may be “normal HD.”

Through a comparison between the first image quality level and the second image quality level, it can be seen that the first image quality level corresponds to the video having a high bit rate, and the second image quality level corresponds to the video having a low bit rate. The image quality selection strategy of the user who performs the switch operation corresponding to the switch command can be predicted based on the switch command and the video information of the target video corresponding to the video instruction. The image quality selection strategy determined through the user's operation matches the user's preference for image quality. Therefore, loading and playing the video to be played in the video information stream based on the image quality selection strategy can meet the user's need for image quality.

Hereinafter, an implementation of step S102 according to a detailed embodiment will be described:

As an example, the video information includes a buffer duration for characterizing a time length for buffering a target video during play. Determining the image quality selection strategy includes:
acquiring a first play duration of the target video before triggering the switch command; in the case where the buffer duration of the target video is greater than a buffer duration threshold, if the first play duration is less than a play duration threshold, the image quality selection strategy is the high fluency strategy; if the first play duration is greater than a play duration threshold, the image quality selection strategy is the high image quality strategy.

When the buffer duration of the target video is greater than the buffer duration threshold, it indicates the problem of a too long buffer duration (i.e., freezing) during play of the target video. In the case, if the first play duration is less than the play duration threshold, it is indicated that the user switches the target video in a short time upon freezing, which means that the user is sensitive to freezing. Therefore, it is predicted that the image quality selection strategy is the high fluency strategy. In turn, if the first play duration is greater than the play duration threshold, it is indicated that the user switches the target video in a long time after freezing, or does not switch the target video, which means that the user is not sensitive to freezing. Accordingly, it is predicted that the image quality selection strategy is the high image quality strategy.

Further, in a possible implementation, video information includes resolution, and/or frame rate.

When the buffer duration of the target video is less than the buffer duration threshold, the resolution, and/or frame rate, of the target video is obtained. If the resolution of the target video is greater than a preset resolution threshold, and/or if the frame rate of the target video is greater than a preset frame rate threshold, the image quality selection strategy is the high image quality strategy; if the resolution of the target video is less than the preset resolution threshold, and/or the frame rate of the target video is less than the preset frame rate threshold, the image quality selection strategy is the high fluency strategy.

By means of example, the resolution is a parameter characterizing a video definition, where a higher resolution indicates a higher video definition; and a frame rate is a parameter characterizing a video fluency, where a higher frame rate indicates more frames of a video per unit of time, and the video is therefore smoother. Moreover, a higher resolution and a higher frame rate of a video indicate a higher bit rate of the video, i.e., more bandwidths are occupied and more traffic is costed for loading the video.

When the buffer duration of the target video is less than the buffer duration threshold, it is indicated that the target video does not obviously freeze; if the resolution of the target video is greater than the preset resolution threshold, and/or the frame rate of the target video is greater than preset frame rate threshold, it is indicated that the user sets the resolution, and/or the frame rate, during video play to a high level through the preset parameters, i.e., the user tends to play the video in the form of high image quality and high bit rate. In the case, the image quality selection strategy is the high image quality strategy.

In the step according to the embodiments, in the case where the buffer duration of the target video is less than the buffer duration threshold, by obtaining parameters of a target video, such as a resolution, a frame rate, and the like, and predicting an image quality selection strategy, it can be achieved to further improve the accuracy in determining the user's preference for image quality while broadening the range of application scenarios.

In a possible implementation, the high image quality strategy corresponds to a network condition, and a first image quality level includes at least two image quality sub-levels, i.e., in a network condition, the high image quality strategy corresponds to two or more image quality sub-levels, for example, “ultra HD” and “HD.” In a possible implementation, when determining a target image quality level based on the image quality selection strategy and the current network condition, one is selected randomly from a plurality of image quality sub-levels. However, in a further possible implementation, a target sub-level in the first image quality level is determined based on the resolution, and/or frame rate, of the target video. For example, there are four levels for image quality adjustment, including “Blu-ray,” “ultra HD,” “HD,” and “normal HD,” where “Blu-ray,” “ultra HD,” and “HD” are three sub-levels in the first image quality level. The resolution of the target video is acquired. Based on the resolution of the target video, a level closest to its resolution is selected. For example, “ultra HD” is the target sub-level in the first image quality level. In the following step, the target sub-level serves as the target image quality level for loading and playing the video to be played in the video information stream.

In the step according to the embodiment, by acquiring the resolution and/or frame rate of the target video and determining a target sub-level matching the target video from the first image quality level including a plurality of sub-levels, it can be achieved to further boost the accuracy in determining the image quality level, increase the match degree with the user's preference for image quality, and improve user's watching experience.

The buffer duration threshold, the play duration threshold, the resolution threshold, and the frame rate threshold can be set as actually required, which are not specifically limited herein.

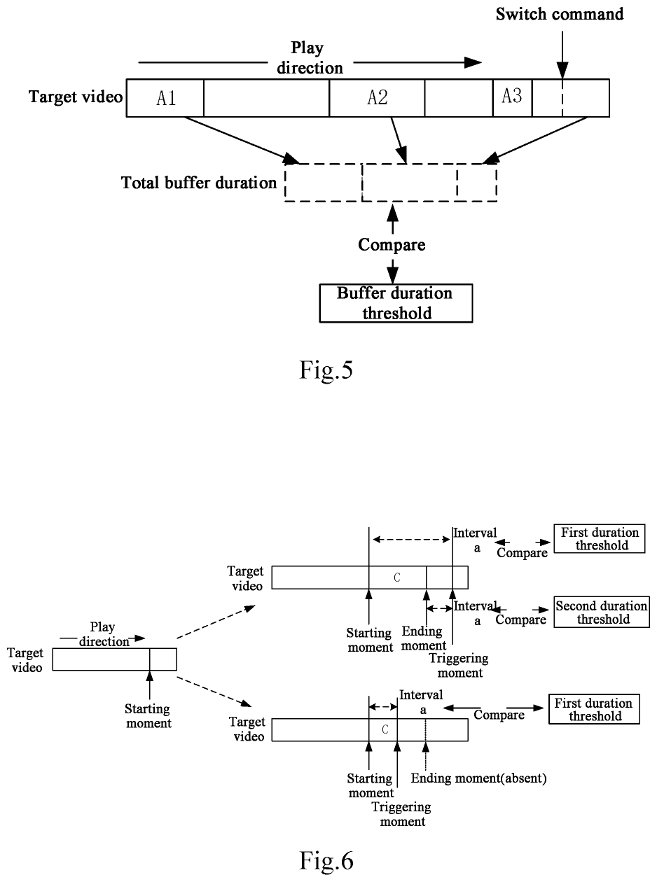

FIG. 5 illustrates a schematic diagram of determining, based on a buffering duration of a target video, an image quality selection strategy provided by embodiments of the present disclosure. As shown therein, the target video is played in the play direction, and the terminal device obtains a total buffer duration of the target video after receiving the switch command for the target video. Specifically, before the switch command is received, the target video is buffered three times, respectively corresponding to three buffer sub-intervals A1, A2 and A3, and the total buffer duration is a sum of durations corresponding to A1, A2 and A3. Based on the comparison between the total buffer duration and the buffer duration threshold, whether the target video freezes is determined. Specifically, if the total buffer duration is greater than the buffer duration threshold, it is determined that the target video has frozen; if the total buffer duration is less than or equal to the buffer duration threshold, it is determined that the target video has not frozen. Then, in the case of freezing and not freezing, a respective image quality selection strategy is determined respectively based on the first play duration and the resolution of the target video.

In the step according to the embodiment, the overall freezing condition of the target video is determined based on the obtained total buffer duration of the target video, and the video image quality selection strategy is further determined based on the user's response to the overall freezing condition (the switch command), to predict the user's preference for image quality. In this way, it can be achieved to avoid the problem of more operation steps resulting from the user's manual setting, which affects the user's experience in video watching.

In a further possible implementation, the terminal device can also determine the image quality selection strategy based on the response (the switch command) made by the user when the target video frozen the first time. FIG. 6 illustrates a further schematic diagram of determining, based on a buffer duration of a target video, an image quality selection strategy provided by embodiments of the present disclosure. As shown therein, upon receiving the switch command for the target video, the terminal device obtains a starting moment, an ending moment (if any), and a triggering moment when the switch command is triggered, of a buffer interval (shown as C) where the target video freezes. At this time, there are two cases. If the triggering moment follows the ending moment, the ending moment exists; if the triggering moment precedes the ending moment, there is no ending moment. Then, if an interval between the starting moment and the triggering moment (shown as interval a) is less than a first duration threshold, the image quality selection strategy is the high fluency strategy; if an interval between the starting moment and the ending moment (shown as interval b) is greater than a second duration threshold, the image quality selection strategy is the high image quality strategy.

In the step according to the embodiments, when an interval from the starting moment to the triggering moment is less than the first duration threshold, it indicates that the user switches videos in a short time upon occurrence of freezing, and then, it is predicted that the user is sensitive to freezing. Therefore, it is determined that the image quality selection strategy is the high fluency strategy. As the high fluency strategy always corresponds to a low image quality level in different network conditions, the video fluency can be efficiently improved. If the interval from the starting moment to the ending moment is greater than the second duration threshold, it indicates that the user waits for the whole video buffering process which lasts a relatively long time, and then, it is predicted that the user is insensitive to freezing and prefers videos with high image quality. Thus, it is determined that the image quality selection strategy is the high image quality strategy. As the high image quality strategy always corresponds to a high image quality level, the image quality of the videos can be efficiently improved, and the definition can be increased. By determining the user's image quality selection strategy based on the user's response after video buffering occurred, it can be achieved to further promote the accuracy in predicting the user's preference, and improve the user experience in watching.

It is worth noting that the methods of determining an image selection strategy respectively corresponding to FIGS. 5 and 6 may be used alone or in combination. When they are used in combination, priorities of the two methods can be determined based on a preset configuration or the network condition, details of which are omitted here for brevity.

Step S103: determining a target image quality level based on the image quality selection strategy and the current network condition, and playing the video to be played in the video information stream based on the target image quality level.

As an example, after determining the image quality selection strategy, i.e., determining the respective image quality levels adapted to different network conditions of, for example, the download speed being less than 100 kbps, 100 kbps to 500 kbps, and 500 kbps to 2 Mbps, the corresponding image quality levels are “normal HD,” “HD,” and “ultra HD,” respectively. Thereafter, by detecting the current network download speed, the terminal device can determine the corresponding target image quality level based on the image quality selection strategy. For example, when the current download speed is 300 kbps, the terminal device can determine, based on the above image quality selection strategy, that the target image quality level is “HD.” Further, based on the target image quality level, the video to be played in the subsequent video information stream is preloaded and played such that the image quality of the video to be played can match the image quality preference desired by the user, to thus provide the ideal user experience in watching. Matching the corresponding data file at the server side based on the image profile level, and the data loading and playing process, are all related technologies known to those skilled in the art, details of which are omitted here for brevity.

In the embodiment, the switch command for the video information stream is received, which is used to switch the target video played in the video information stream; based on the switch command, and the video information of the target video corresponding to the switch command, the image quality selection is determined which is used to characterize an image quality level when plying a video to be played in the video information stream in different network conditions; the target image quality level is determined based on the image quality selection strategy and the current network condition, and the video to be played in the video information stream is played based on the target image quality level. Since the user's switch command for the video information stream can embody the user's need for the video image quality, the video image quality selection strategy determined through the switch command can enable automatic selection of video image quality as desired by the user, not just depending on the network speed as the only influence factor of the video image quality, it can meet the user's personalized need for image quality in different network speed conditions, and improve the user experience in watching the video in the video information stream.

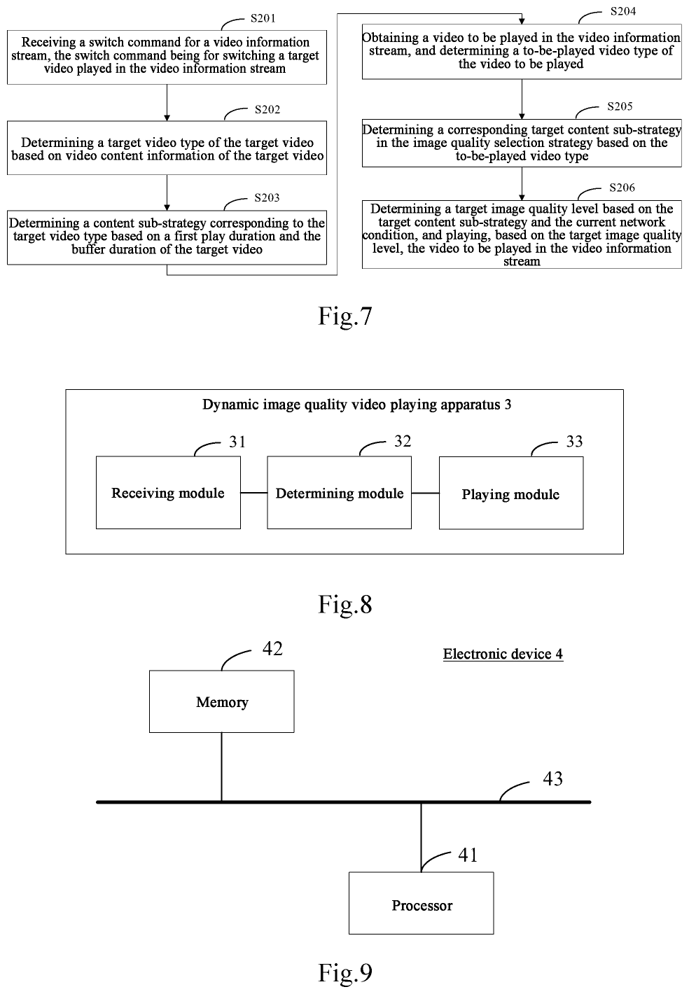

FIG. 7 illustrates a flowchart II of a dynamic image-quality video playing method provided by embodiments of the present disclosure. On the basis of the embodiments shown in FIG. 3, the embodiments include an additional step of determining the image quality selection strategy based on video content information of the target video, where the video information includes video content information for characterizing a video type of a video, and a buffer duration for characterizing a time length of buffering the target video during play; the image quality selection strategy includes at least two content sub-strategies each for characterizing an image quality level when playing a video to be played corresponding to the video type in different network conditions. The dynamic image quality video playing method includes:
Step S201: receiving a switch command for the video information stream, where the switch command is used to switch a target video being played in the video information stream.
Step S202: determining a target video type of the target video based on video content information of the target video.

As an example, the video content information is information characterizing a type of a content of the target video, for example, “teaching video,” “funny video,” “news video” and the like. The video content information may include a video type flag, and a different video type flag corresponds to a respective video type. Upon receiving the switch command for the video information stream, the terminal device obtains video content information of the target video pre-stored locally or on the server, and then determines a target type corresponding to the target video.
Step 203: based on a first play duration and a buffer duration of the target video, determining a content sub-type corresponding to the target video type.

With respect to videos of different types, different users have different preferences for image quality. Specifically, for some performance-focused videos such as “movie clip,” “creative video” and the like, users tend to prefer watching high-definition videos; for some content-focused videos such as “news video” and “funny video,” users tend to prefer fluency to definition. Such preferences for image quality of different types of videos are personalized, i.e., they are varied with different users. Therefore, determining a content sub-strategy corresponding to a video of a different type for a user is conductive to further improving the match degree with the user's preference.

Specifically, the first play duration of the target video is a time length of playing the target video before triggering the switch command, i.e., how long the user watched the target video. The first play duration indicates the user's preference on video freezing. In the case where the target video buffer duration is greater than a preset duration, if the first play duration is relatively long, it is indicated that the user is insensitive to video freezing for this type of video; otherwise, it is indicated that the user is sensitive to video freezing for this type of video.

Hence, based on the first play duration and the buffer duration of the target video, the content sub-strategy corresponding to the target video type is determined to be implemented in such a way that: for example, in the case where the buffer duration of the target video is greater than the buffer duration threshold, if the first play duration is less than a play duration threshold, it is determined that the content sub-strategy corresponding to the target video type is the high fluency strategy, and if the first play duration is greater than the play duration threshold, it is determined that the content sub-strategy corresponding to the target video type is the high image quality strategy.

As an example, there may be a plurality of target videos, where each target video corresponds to a piece of video content information. Correspondingly, a plurality of switch commands are provided, where each switch command corresponds to a respective target video. Specifically, the user implements the switch operation multiple times via the touchscreen of the terminal device, to switch the target video being played in the video information stream; the terminal device obtains, based on a respective target video corresponding to each switch operation, video content information of the respective target video, namely a first play duration and a buffer duration, and determines, based on the first play duration and the buffer duration, a content sub-strategy corresponding to a type of the respective target video and further generates the image quality selection strategy.
Step S204: obtaining a video to be played in the video information stream, and determining a to-be-played type of the video to be played.
Step S205: determining, based on the to-be-played type of the video to be played, a corresponding target content sub-strategy in the image quality selection strategy.
Step S206: determining a target image quality level based on the target content sub-strategy and the current network condition, and playing, based on the target image quality level, the video to be played in the video information stream.

Further, subsequent to determining the image quality selection strategy including a plurality of content sub-strategies, a corresponding content sub-strategy, namely a target content sub-strategy, is selected based on the type of the video to be played by obtaining video to be played in the video information stream and determining the type of the video to be played. Then, a matched target image quality level in the current network condition is determined based on a mapping relationship between a network condition characterized by the target content sub-strategy and the target image quality level, and a subsequent video is played at the target image quality level, to dynamically set image quality for a specific video type, a specific image quality selection strategy, and a specific network condition, and improve a match degree of video image quality with the user's preference for image quality.

The dynamic image quality video playing method provided by the embodiments is a technical solution implemented on the basis of the embodiments as shown in FIG. 3, i.e., on the basis of the embodiment as shown in FIG. 3, a video type is further considered to determine the image quality selection strategy. Accordingly, in the step of determining the image quality selection strategy in these embodiments, subsequent to determining the video type of the target video, the implementation method and the technical effect of determining an image quality selection strategy based on the target video of a specific type are similar to those of the step of determining the image quality selection strategy in the embodiments as shown in FIG. 3. See the description about the embodiment as shown in FIG. 3 for details, which are omitted here for brevity.

In the step of the embodiments, by obtaining switch commands multiple times, and video information of target videos corresponding to the switch commands, image quality selection strategies for playing videos to be played corresponding to the respective video types in different network conditions are constructed such that processing can be performed based on the different image quality selection strategies when playing the videos to be played of different types, so as to dynamically set image quality for different types of videos. Further, since dynamically setting image quality for different types of videos is dependent on the user's operation, the setting can match the user's preference for image quality. In this way, it can further promote the match degree of the video image quality with the user's preference for image quality and improve the user's watching experience.

In the embodiments, the implementation manner of step S201 is identical to that of step S101 in the embodiment shown in FIG. 3, details of which are omitted here for brevity.

Corresponding to the dynamic image quality video playing method according to the above-mentioned embodiments, FIG. 8 illustrates a schematic diagram of a structure of a dynamic image-quality video playing apparatus provided by embodiments of the present disclosure. For ease of description, only components related to the embodiments of the present disclosure are shown. Referring to FIG. 8, a dynamic image quality video playing apparatus 3 includes:
a receiving module 31 for receiving a switch command for a video information stream, where the switch command is used to switch a target video in the video information stream;
a determining module 32 for determining an image quality selection strategy based on the switch command, and video information of the target video corresponding to the switch command, where the image quality selection strategy is used to characterize an image quality level when playing a video to be played in the video information stream in a different network condition; and
a playing module 33 for determining a target image quality level based on the image selection strategy and a current network condition, and playing, based on the target image quality level, the video to be played in the video information stream.

In an embodiment of the present disclosure, the image quality selection strategy includes a high image quality strategy for indicating the terminal device to play the video to be played in the video information stream at a first image quality level in a first network condition, or a high fluency strategy for indicating the terminal device to play the video to be played in the video information stream at a second image quality level in the first network condition, where a bit rate corresponding to the first image quality level is greater than a bit rate corresponding to the second image quality level.

In an embodiment of the present disclosure, the video information includes a buffer duration for characterizing a time length for buffering the target video during play; the determining module 32 is specifically configured to: obtain a first play duration of the target video before triggering the switch command; in a case where the buffer duration of the target video is greater than a buffer duration threshold, if the first play duration is less than a play duration threshold, determine that the image quality selection strategy is the high fluency strategy, and if the first play duration is greater than the play duration threshold, determining that the image quality selection strategy is the high image quality strategy.

In an embodiment of the present disclosure, the video information may further include a resolution, and/or a frame rate; the determining module 32 is specifically configured to: obtain a resolution, and/or a frame rate when the buffer duration of the target video is less than a buffer duration threshold; if the resolution of the target video is greater than a preset resolution threshold, and/or the frame rate of the target video is greater than a preset frame rate threshold, determine that the image quality selection strategy is the high image quality strategy.

In an embodiment of the present disclosure, the first image quality level includes at least two image quality sub-levels; when determining the target image quality level based on the image quality selection strategy and the current network condition, the playing module 33 is specifically configured to: determine, based on the current network condition, at least two image quality sub-levels if the image quality selection strategy is the high image quality strategy; and determine a target image quality sub-level based on the resolution, and/or the frame rate, of the target video and the at least two image quality sub-levels.

In an embodiment of the present disclosure, when determining the image quality selection strategy based on the switch command, and the video information of the target video corresponding to the switch command, the determining module 32 is specifically configured to: obtain a starting moment of buffering the target video during play of the target video; obtain a triggering moment when the switch command is triggered; and determine the high fluency strategy as the image quality selection strategy if an interval between the starting movement and the triggering moment is less than a first duration threshold.

In an embodiment, the determining module 32 is further configured to: obtain an ending moment of buffering the target video; and determine that the image quality selection strategy is the high image quality strategy if an interval between the starting moment and the ending moment is greater than a second duration threshold.

In an embodiment of the present disclosure, the video information includes video content information for characterizing a video type of a video, and a buffer duration for characterizing a time length for buffering the target video during play; the image quality selection strategy includes at least two content sub-strategies for characterizing an image quality level when playing a video to be played corresponding to the video type in a different network condition; the determining module 32 is specifically configured to: determine a target video type of the target video based on the video content information of the target video; and determine a content sub-strategy corresponding to the target video type based on the first play duration and the buffer duration of the target video.

In an embodiment of the present disclosure, when determining the target image quality level based on the image quality selection strategy and the current network condition, the playing module 33 is specifically configured to: obtain a video to be played in the video information stream, and determine a to-be-played video type of the video to be played; determine, based on the to-be-played video type, a target content sub-strategy in the image quality selection strategy; and determine a target image quality level based on the target content sub-strategy and the current network condition.

The receiving module 31, the determining module 32 and the playing module 33 are connected sequentially. The dynamic image quality video playing apparatus 3 provided by the embodiments can be used to implement the technical solution of the method embodiments as mentioned above. The principle and the technical effect thereof are similar, details of which are omitted here for brevity.

The apparatus provided by the embodiments can be used to implement the technical solution of the method embodiments as mentioned above. The principle and the technical effect thereof are similar, details of which are omitted here for brevity.

FIG. 9 illustrates a schematic diagram of a structure of an electronic device provided by embodiments of the present disclosure. As shown therein, the electronic device 4 includes:
a processor 41, and a memory 42 communicatively connected with the processor 41;
the memory 42 having computer execution instructions stored thereon;
the processor 41 executing the computer execution instructions stored in the memory 42, to implement the dynamic image quality video playing method according to embodiments as shown in FIGS. 3-7.

Alternatively, the processor 41 and the memory 42 are connected via a bus 43.

The related illustration thereof may be understood with reference to the description and the effect corresponding to steps in the embodiments corresponding to FIGS. 3-7, details of which are omitted here for brevity.

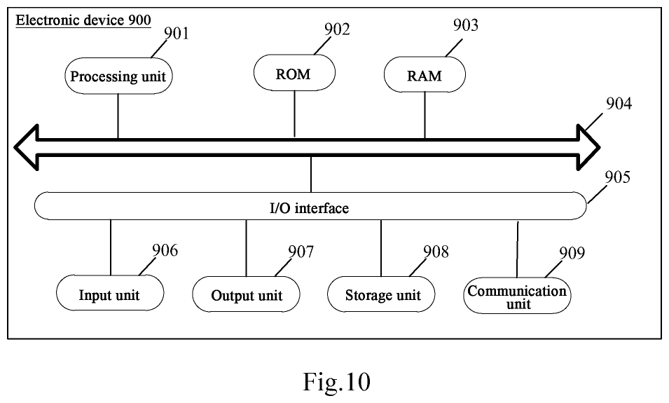

FIG. 10 illustrates a schematic diagram of a structure of the electronic device 900 adapted to implement embodiments of the present disclosure, where the electronic device 900 may be a terminal device or a server. The terminal device may include, but is not limited to, a mobile terminal such as a mobile phone, a laptop computer, a digital broadcast receiver, a Personal Digital Assistant (PDA), a Portable Android Device (PAD), a Portable Media Player (PMP), an on-vehicle terminal (e.g. an on-vehicle navigation terminal) or the like, or a fixed terminal such as a digital TV, a desktop computer or the like. The electronic device as shown in FIG. 10 is provided merely as an example, without suggesting any limitation to the functions and the application range of the embodiments of the present disclosure.

As shown therein, the electronic device 900 may include processing unit 901 (e.g. a central processor, a graphics processor and the like), which can execute various actions and processing based on programs stored in a Read Only Memory (ROM) 902 or a program loaded from storage unit 908 to a Random Access Memory (RAM) 903. RAM 903 stores therein various programs and data required for operations of the electronic device 900. The processing unit 901, the ROM 902 and the RAM 903 are connected to one another via a bus 904. An input/output (I/O) interface 905 is also connected to the bus 904.

Typically, the following units may be connected to the I/O interface 905: input unit 906 including, for example, a touchscreen, a touch pad, a keyboard, a mouse, a camera, a microphone, an accelerometer, a gyroscope and the like; output unit 904 including, for example, a Liquid Crystal Display (LCD), a loudspeaker, a vibrator and the like; storage unit 908 including, for example, a tape, a hard drive and the like; and communication unit 909. The communication unit 902 can allow wireless or wired communication of the electronic device 900 with other devices to exchange data. Although FIG. 10 shows the electronic device 900 including various unit, it would be appreciated that not all of the unit as shown are required to be implemented or provided. Alternatively, more or fewer unit may be implemented or provided.

In particular, according to embodiments of the present disclosure, the processes described above with reference to the flowcharts may be implemented as computer software programs. For example, embodiments of the present disclosure include a computer program product comprising a computer program carried on a non-transitory computer readable medium, the computer program containing program code for performing the methods illustrated by the flowcharts. In those embodiments, the computer program may be downloaded and installed from a network via the communication unit 909, or may be installed from the storage unit 908, or may be installed from the ROM 902. The computer program, when executed by the processing unit 901, performs the above-described functions defined in the methods according to the embodiments of the present disclosure.

It should be noted that the computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain, or store a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

The computer-readable medium may be the one included in the electronic device, or may be provided separately, rather than assembled in the electronic device.

The computer-readable medium carries one or more programs which, when executed by the electronic device, cause the electronic device to perform the methods according to the embodiments as described above.

Computer program code for carrying out operations according to the present disclosure may be written in any combination of one or more programming languages, including but not limited to an object oriented programming language such as Java, Smalltalk, C++, and conventional procedural programming languages, such as the “C” programming language or similar programming languages. The program code may be executed entirely on the user's computer, partly on the user's computer, as a stand-alone software package, partly on the user's computer and partly on a remote computer or entirely on the remote computer or server. In the case of a remote computer, the remote computer may be connected to the user's computer through any type of network, including a Local Area Network (LAN) or a Wide Area Network (WAN), or the connection may be made to an external computer (for example, through the Internet using an Internet service provider).

The flowchart and block diagrams in the drawings illustrate the functionality and operation of possible implementations of methods, apparatus and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

The units described in the embodiments of the present disclosure may be implemented by software or hardware. Wherein, the designation of a module or unit does not in some cases constitute a limitation of the unit itself. For example, the first obtaining unit may also be described as “a unit for obtaining at least two Internet Protocol addresses.”

The functions described herein above may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSPs), Systems on Chip (SOCs), Complex Programmable Logic Devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a computer-readable storage medium would include an electrical connection based on one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

In a first aspect, according to one or more embodiments of the present disclosure, there is provided a dynamic image quality video playing method, comprising:
receiving a switch command for a video information stream, the switch command for switching a target video played in the video information stream; determining an image quality selection strategy based on the switch command, and video information of the target video corresponding to the switch command, the image quality selection strategy for characterizing image quality levels when playing a video to be played in the video information stream in different network conditions; and determining a target image quality level based on the image quality selection strategy and a current network condition, and playing, based on the target image quality level, the video to be played in the video information stream.

According to one or more embodiments of the present disclosure, the image quality selection strategy comprises a high image quality strategy for indicating a terminal device to play the video to be played in the video information stream at a first image quality level in a first network condition, or a high fluency strategy for indicating the terminal device to play the video to be played in the video information stream at a second image quality level in the first network condition, and a bit rate corresponding to the first image quality level is greater than a bit rate corresponding to the second image quality level.

According to one or more embodiments of the present disclosure, the video information comprises a buffer duration for characterizing a time length for buffering the target video during play; and determining the image quality selection strategy based on the switch command, and the video information of the target video corresponding to the switch command, comprises: obtaining a first play duration of the target video before triggering the switch command; in a case where a buffer duration of the target video is greater than a buffer duration threshold, if the first play duration is less than a play duration threshold, determining that the image quality selection strategy is the high fluency strategy, and if the first play duration is greater than the play duration threshold, determining that the image quality selection strategy is the high image quality strategy.

According to one or more embodiments of the present disclosure, the video information further comprises a resolution, and/or a frame rate, the method further comprising: when the buffer duration of the target video is less than a buffer duration threshold, obtaining a resolution, and/or a frame rate, of the target video; and if the resolution of the target video is greater than a preset resolution threshold, and/or the frame rate of the target video is greater than a preset frame rate threshold, determining that the image quality selection strategy is the high image quality strategy.

According to one or more embodiments of the present disclosure, the first image quality level comprises at least two image quality sub-levels; determining the target image level based on the image quality selection strategy and the current network condition, comprises: if the image quality selection strategy is the high image quality strategy, determining at least two image quality sub-levels based on the current network condition; and determining a target image quality sub-level based on the resolution, and/or the frame rate, of the target video, and the at least two image quality sub-levels.

According to one or more embodiments of the present disclosure, determining the image quality selection strategy based on the switch command, and the video information of the target video corresponding to the switch command, comprises: obtaining a starting moment of buffering the target video during play of the target video; obtaining a triggering moment of trigging the switch command; and if an interval between the starting moment and the triggering moment is less than a first duration threshold, determining that the image quality selection strategy is the high fluency strategy.

According to one or more embodiments of the present disclosure, the method further comprises: obtaining an ending moment of buffering the target video during play of the target video; and if an interval between the starting moment and the ending moment is greater than a second duration threshold, determining that the image quality selection strategy is the high image quality strategy.

According to one or more embodiments of the present disclosure, the video information includes video content information for characterizing a video type of a video, and a buffer duration for characterizing a time length for buffering the target video during play; the image quality selection strategy comprises at least two content sub-strategies for characterizing image quality levels for playing a video to be played corresponding to the video type in different network conditions; determining the image quality selection strategy based on the switch command, and the video information of the target video corresponding to the switch command, comprises: determining a target video type of the target video based on video content information of the target video; and determining a content sub-strategy corresponding to the target video type based on a first play duration and the buffer duration of the target video.

According to one or more embodiments of the present disclosure, determining the target image quality level based on the image quality selection strategy and the current network condition, comprises: obtaining a video to be played in the video information stream, and determining a to-be-played video type of the video to be played; determining a corresponding target content sub-strategy in the image quality selection strategy based on the to-be-played video type; and determining a target image quality level based on the target content sub-strategy and the current network condition.

In a second aspect, according to one or more embodiments of the present disclosure, there is provided a dynamic image quality video playing apparatus, comprising:
a receiving module for receiving a switch command for a video information stream, the switch command for switching a target video played in the video information stream;
a determining module for determining an image quality selection strategy based on the switch command, and video information of the target video corresponding to the switch command, the image quality selection strategy for characterizing image quality levels when playing a video to be played in the video information stream in different network conditions; and
a playing module for determining a target image quality level based on the image quality selection strategy and a current network condition, and playing, based on the target image quality level, the video to be played in the video information stream.

According to one or more embodiments of the present disclosure, the image quality selection strategy comprises a high image quality strategy for indicating a terminal device to play the video to be played in the video information stream at a first image quality level in a first network condition, or a high fluency strategy for indicating the terminal device to play the video to be played in the video information stream at a second image quality level in the first network condition, and a bit rate corresponding to the first image quality level is greater than a bit rate corresponding to the second image quality level.

According to one or more embodiments of the present disclosure, the video information comprises a buffer duration for characterizing a time length for buffering the target video during play; and the determining module is specifically configured to: obtain a first play duration of the target video before triggering the switch command; in a case where a buffer duration of the target video is greater than a buffer duration threshold, if the first play duration is less than a play duration threshold, determine that the image quality selection strategy is the high fluency strategy, and if the first play duration is greater than the play duration threshold, determine that the image quality selection strategy is the high image quality strategy.

According to one or more embodiments of the present disclosure, the video information further comprises a resolution, and/or a frame rate; the determining module is further configured to: when the buffer duration of the target video is less than a buffer duration threshold, obtain a resolution, and/or a frame rate, of the target video; and if the resolution of the target video is greater than a preset resolution threshold, and/or the frame rate of the target video is greater than a preset frame rate threshold, determine that the image quality selection strategy is the high image quality strategy.

According to one or more embodiments of the present disclosure, the first image quality level comprises at least two image quality sub-levels; when determining the target image level based on the image quality selection strategy and the current network condition, the playing module is specifically configured to: if the image quality selection strategy is the high image quality strategy, determine at least two image quality sub-levels based on the current network condition; and determine a target image quality sub-level based on the resolution, and/or the frame rate, of the target video, and the at least two image quality sub-levels.

According to one or more embodiments of the present disclosure, when determining the image quality selection strategy based on the switch command, and the video information of the target video corresponding to the switch command, the determining module is specifically configured to: obtain a starting moment of buffering the target video during play of the target video; obtain a triggering moment of trigging the switch command; and if an interval between the starting moment and the triggering moment is less than a first duration threshold, determine that the image quality selection strategy is the high fluency strategy.

According to one or more embodiments of the present disclosure, the determining module is further configured to: obtain an ending moment of buffering the target video during play of the target video; and if an interval between the starting moment and the ending moment is greater than a second duration threshold, determine that the image quality selection strategy is the high image quality strategy.

According to one or more embodiments of the present disclosure, the video information includes video content information for characterizing a video type of a video, and a buffer duration for characterizing a time length for buffering the target video during play; the image quality selection strategy comprises at least two content sub-strategies for characterizing image quality levels for playing a video to be played corresponding to the video type in different network conditions; the determining module is specifically configured to: determine a target video type of the target video based on video content information of the target video; and determine a content sub-strategy corresponding to the target video type based on a first play duration and the buffer duration of the target video.

According to one or more embodiments of the present disclosure, when determining the target image quality level based on the image quality selection strategy and the current network condition, the playing module is specifically configured to: obtain a video to be played in the video information stream, and determine a to-be-played video type of the video to be played; determine a corresponding target content sub-strategy in the image quality selection strategy based on the to-be-played video type; and determine a target image quality level based on the target content sub-strategy and the current network condition.
In a third aspect, according to one or more embodiments of the present disclosure, there is provided an electronic device, comprising: a processor, and a memory communicatively connected with the processor;
the memory storing computer execution instructions;
the processor executing the computer execution instructions stored on the memory to implement the dynamic image quality video playing method of the first aspect and various possible designs of the first aspect.
In a fourth aspect, according to one or more embodiments of the present disclosure, there is provided a computer-readable storage medium having computer execution instructions stored therein, where the computer execution instructions, when executed by a processor, implements the dynamic image quality video playing method of the first aspect and various possible designs of the first aspect.
In a fifth aspect, embodiments of the present disclosure provide a computer program product comprising a computer program, where the computer program, when executed by a processor, implements the dynamic image quality video playing method of the first aspect and various possible designs of the first aspect.
In a sixth aspect, embodiments of the present disclosure provide a computer program, where the computer program, when executed by a processor, implements the dynamic image quality video playing method of the first aspect and various possible designs of the first aspect.

The embodiments provide a dynamic image quality video playing method, apparatus, electronic device and storage medium. The method includes: receiving a switch command for a video information stream, the switch command for switching a target video played in the video information stream; determining an image quality selection strategy based on the switch command, and video information of the target video corresponding to the switch command, the image quality selection strategy for characterizing image quality levels when playing a video to be played in the video information stream in different network conditions; and determining a target image quality level based on the image quality selection strategy and a current network condition, and playing, based on the target image quality level, the video to be played in the video information stream. Since the user's switch command for the video information stream can embody the user's need for the video image quality, the video image quality selection strategy determined through the switch command can implement automatic selection of video image quality as desired by the user, not just depending on the network speed as the only influence factor of the video image quality, it can meet the user's personalized need for image quality in different network speed conditions, and improve the user experience in watching the video in the video information stream.

The terms for messages or information exchanged among multiple units in the embodiments of the present disclosure are provided only for illustration, without suggesting any limitation to the range of those messages or information.

It would be appreciated that, prior to use of the technical solution disclosed by the embodiments of the present application, users should be informed of the type, the range of use, and the use scenarios of personal information in a proper manner in accordance with the pertinent provisions of laws and regulations, and authorization should be gained from the users.

For example, in response to receiving an active request from a user, prompt information should be sent to the user to clearly remind the user that the operation requested will involve acquisition and use of the user's personal information. This allows the user to autonomously choose, based on the prompt information, whether the personal information is to be provided to software or hardware including electronic devices, applications, servers or storage media that perform the operations of the technical solution according to the present disclosure.

As an optional implementation, without limitation, in response to receiving an active request from a user, prompt information may be sent to the user in a manner of, for example, a pop-up window where the prompt information may be presented in the form of text. In addition, the window may also include a selection control for the user to choose “agree” or “disagree” as to providing personal information to the electronic device.

It would be appreciated that the notifying users and acquiring users' authorization are only provided illustratively, not constituting a limitation to the implementations of the present disclosure, and other manners complying with provisions of related laws and regulations can also applied therein.

It is to be understood that the data (including, but not limited to, data per se, or acquisition or use of data) involved in the present disclosure should be compliant with the pertinent provisions of the corresponding laws and regulations.

The above described are only relatively optimal embodiments of the present disclosure and the technical principles applied therein. It will be appreciated by those skilled in the art that the scope of the disclosure herein is not limited to the particular combination of features described above, but also encompasses other embodiments in which any combination of the features described above or their equivalents does not depart from the spirit of the disclosure. For example, the above features and (but not limited to) the features disclosed in this disclosure having similar functions are replaced with each other to form the technical solution.

Further, while operations are depicted in a particular order, this should not be understood as requiring that such operations be performed in the particular order shown or in sequential order. Under certain circumstances, multitasking and parallel processing may be advantageous. Likewise, while several specific implementation details are included in the above discussion, these should not be construed as limitations on the scope of the disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A dynamic image quality video playing method, comprising:
receiving a switch command for a video information stream, the switch command being for switching a target video played in the video information stream;
determining an image quality selection strategy based on the switch command and video information of the target video corresponding to the switch command, the image quality selection strategy being for characterizing image quality levels when playing a video to be played in the video information stream in different network conditions; and
determining a target image quality level based on the image quality selection strategy and a current network condition, and playing, based on the target image quality level, the video to be played in the video information stream.

2. The method of claim 1, wherein:
the image quality selection strategy comprises a high image quality strategy or a high fluency strategy, the high image quality strategy being for indicating a terminal device to play the video to be played in the video information stream at a first image quality level in a first network condition, the high fluency strategy being for indicating the terminal device to play the video to be played in the video information stream at a second image quality level in the first network condition, and a bit rate corresponding to the first image quality level is greater than a bit rate corresponding to the second image quality level.

3. The method of claim 2, wherein the video information comprises a buffer duration, the buffer duration being for characterizing a time length for buffering the target video during playing; and
determining the image quality selection strategy based on the switch command and the video information of the target video corresponding to the switch command comprises:
obtaining a first play duration of the target video before triggering the switch command;
in a case where a buffer duration of the target video is greater than a buffer duration threshold, if the first play duration is less than a play duration threshold, determining that the image quality selection strategy is the high fluency strategy, and if the first play duration is greater than the play duration threshold, determining that the image quality selection strategy is the high image quality strategy.

4. The method of claim 3, wherein the video information further comprises a resolution, and/or a frame rate, the method further comprising:
when the buffer duration of the target video is less than a buffer duration threshold, obtaining a resolution, and/or a frame rate, of the target video; and
if the resolution of the target video is greater than a preset resolution threshold, and/or the frame rate of the target video is greater than a preset frame rate threshold, determining that the image quality selection strategy is the high image quality strategy.

5. The method of claim 4, wherein the first image quality level comprises at least two image quality sub-levels; determining the target image level based on the image quality selection strategy and the current network condition comprises:
if the image quality selection strategy is the high image quality strategy, determining at least two image quality sub-levels based on the current network condition; and
determining a target image quality sub-level based on the resolution, and/or the frame rate, of the target video, and the at least two image quality sub-levels.

6. The method of claim 2, wherein determining the image quality selection strategy based on the switch command and the video information of the target video corresponding to the switch command comprises:
obtaining a starting moment of buffering the target video during playing of the target video;
obtaining a triggering moment of trigging the switch command; and
if an interval between the starting moment and the triggering moment is less than a first duration threshold, determining that the image quality selection strategy is the high fluency strategy.

7. The method of claim 6, further comprising:
obtaining an ending moment of buffering the target video during playing of the target video; and
if an interval between the starting moment and the ending moment is greater than a second duration threshold, determining that the image quality selection strategy is the high image quality strategy.

8. The method of claim 2, wherein the video information includes video content information and a buffer duration, the video content information being for characterizing a video type of a video, and the buffer duration being for characterizing a time length for buffering the target video during play; the image quality selection strategy comprises at least two content sub-strategies, the content sub-strategies being for characterizing image quality levels for playing videos to be played corresponding to the video types in different network conditions;
determining the image quality selection strategy based on the switch command and the video information of the target video corresponding to the switch command, comprises:
determining a target video type of the target video based on video content information of the target video; and
determining a content sub-strategy corresponding to the target video type based on a first play duration and the buffer duration of the target video.

9. The method of claim 8, wherein determining the target image quality level based on the image quality selection strategy and the current network condition comprises:
obtaining a video to be played in the video information stream, and determining a to-be-played video type of the video to be played;
determining a corresponding target content sub-strategy in the image quality selection strategy based on the to-be-played video type; and
determining a target image quality level based on the target content sub-strategy and the current network condition.

10. (canceled)

11. An electronic device, comprising:
a memory storing a computer program thereon; and
a processor for execution of the computer program in the memory to perform the method of:
receiving a switch command for a video information stream, the switch command being for switching a target video played in the video information stream;
determining an image quality selection strategy based on the switch command and video information of the target video corresponding to the switch command, the image quality selection strategy being for characterizing image quality levels when playing a video to be played in the video information stream in different network conditions; and
determining a target image quality level based on the image quality selection strategy and a current network condition, and playing, based on the target image quality level, the video to be played in the video information stream.

12. (canceled)

13. A computer program product being stored on a non-transitory computer storage medium and comprising a computer program, wherein the computer program, when executed by a processor, implementing the method of
receiving a switch command for a video information stream, the switch command being for switching a target video played in the video information stream;
determining an image quality selection strategy based on the switch command and video information of the target video corresponding to the switch command, the image quality selection strategy being for characterizing image quality levels when playing a video to be played in the video information stream in different network conditions; and
determining a target image quality level based on the image quality selection strategy and a current network condition, and playing, based on the target image quality level, the video to be played in the video information stream.

14. (canceled)

15. The electronic device of claim 11, wherein:
the image quality selection strategy comprises a high image quality strategy or a high fluency strategy, the high image quality strategy being for indicating a terminal device to play the video to be played in the video information stream at a first image quality level in a first network condition, the high fluency strategy being for indicating the terminal device to play the video to be played in the video information stream at a second image quality level in the first network condition, and a bit rate corresponding to the first image quality level is greater than a bit rate corresponding to the second image quality level.

16. The electronic device of claim 15, wherein the video information comprises a buffer duration, the buffer duration being for characterizing a time length for buffering the target video during playing; and
determining the image quality selection strategy based on the switch command and the video information of the target video corresponding to the switch command comprises:
obtaining a first play duration of the target video before triggering the switch command;
in a case where a buffer duration of the target video is greater than a buffer duration threshold, if the first play duration is less than a play duration threshold, determining that the image quality selection strategy is the high fluency strategy, and if the first play duration is greater than the play duration threshold, determining that the image quality selection strategy is the high image quality strategy.

17. The electronic device of claim 16, wherein the video information further comprises a resolution, and/or a frame rate, the method further comprising:
when the buffer duration of the target video is less than a buffer duration threshold, obtaining a resolution, and/or a frame rate, of the target video; and
if the resolution of the target video is greater than a preset resolution threshold, and/or the frame rate of the target video is greater than a preset frame rate threshold, determining that the image quality selection strategy is the high image quality strategy.

18. The electronic device of claim 17, wherein the first image quality level comprises at least two image quality sub-levels; determining the target image level based on the image quality selection strategy and the current network condition comprises:
if the image quality selection strategy is the high image quality strategy, determining at least two image quality sub-levels based on the current network condition; and
determining a target image quality sub-level based on the resolution, and/or the frame rate, of the target video, and the at least two image quality sub-levels.

19. The electronic device of claim 15, wherein determining the image quality selection strategy based on the switch command and the video information of the target video corresponding to the switch command comprises:
obtaining a starting moment of buffering the target video during playing of the target video;
obtaining a triggering moment of trigging the switch command; and
if an interval between the starting moment and the triggering moment is less than a first duration threshold, determining that the image quality selection strategy is the high fluency strategy.

20. The electronic device of claim 19, further comprising:
obtaining an ending moment of buffering the target video during playing of the target video; and
if an interval between the starting moment and the ending moment is greater than a second duration threshold, determining that the image quality selection strategy is the high image quality strategy.

21. The electronic device of claim 15, wherein the video information includes video content information and a buffer duration, the video content information being for characterizing a video type of a video, and the buffer duration being for characterizing a time length for buffering the target video during play; the image quality selection strategy comprises at least two content sub-strategies, the content sub-strategies being for characterizing image quality levels for playing videos to be played corresponding to the video types in different network conditions;
determining the image quality selection strategy based on the switch command and the video information of the target video corresponding to the switch command, comprises:
determining a target video type of the target video based on video content information of the target video; and
determining a content sub-strategy corresponding to the target video type based on a first play duration and the buffer duration of the target video.

22. The electronic device of claim 21, wherein determining the target image quality level based on the image quality selection strategy and the current network condition comprises:
obtaining a video to be played in the video information stream, and determining a to-be-played video type of the video to be played;
determining a corresponding target content sub-strategy in the image quality selection strategy based on the to-be-played video type; and
determining a target image quality level based on the target content sub-strategy and the current network condition.

23. The computer program product of claim 13, wherein:
the image quality selection strategy comprises a high image quality strategy or a high fluency strategy, the high image quality strategy being for indicating a terminal device to play the video to be played in the video information stream at a first image quality level in a first network condition, the high fluency strategy being for indicating the terminal device to play the video to be played in the video information stream at a second image quality level in the first network condition, and a bit rate corresponding to the first image quality level is greater than a bit rate corresponding to the second image quality level.
